(19) United States
(12) Patent Application Publication
(10) Pub. No.: US 2019/0226542 A1
(43) Pub. Date: Jul. 25, 2019

(54) BRAKE PAD WEAR SENSOR

(71) Applicant: TRW AUTOMOTIVE U.S. LLC, Livonia, MI (US)

(72) Inventors: XING PING LIN, West Bloomfield, MI (US); DAVID JUZSWIK, Commerce TWP, MI (US)

(21) Appl. No.: 16/340,435

(22) PCT Filed: Oct. 13, 2017
(86) PCT No.: PCT/US17/56536

§ 371 Date: Apr. 9, 2019

Related U.S. Application Data
(60) Provisional application No. 62/408,878, filed on Oct. 17, 2016.

(51) Int. Cl. F16D 66/02; B60T 17/22; F16D 51/20

(52) U.S. Cl. CPC F16D 66/023; F16D 51/20; F16D 66/028; B60T 17/221

(57) ABSTRACT

A brake pad wear measuring system for measuring brake pad wear for a vehicle disc brake system includes a first and second coil excitable to create a first and second magnetic field and first and second targets associated with the first and second coils. The coils and targets are configured for movement relative to each other along an axis in response to application of the disc brake system. The relative movement along the axis causes the targets to move within the magnetic fields and affect the inductance of the coils. The first coil and the first target are configured so that the inductance of the first coil is indicative of the amount of brake pad wear. The inductance of the second coil is indicative of component shifting transverse to the axis.

### TECHNICAL FIELD

The invention relates generally to brake pad wear sensing systems and devices. More particularly, the invention relates to a brake pad wear sensor that measures wear in both inner and outer brake pads of a disc braking system.

### BACKGROUND

It is desirable to sense and inform the driver when automotive brake pads need to be replaced. Known electronic brake wear sensors have a resistor circuit sensor that is clipped to the inner brake pad. As the pad is abraded away by the rotor, the sensor is also abraded away, changing its resistance. A pigtail harness is connected to the sensor which is wired to a sensing module in the vehicle.

There are several problems with the known approach. The multiple wire harnesses required and the additional sensing module makes this an expensive solution. Routing of the harnesses through the vehicle suspension and the wheel/steering knuckle area is very challenging and prone to road debris abuse. Additionally, the wear sensor has to be replaced each time the pads are replaced, which can be expensive.

While employing electronic sensors to detect brake pad wear, it is important to consider that the brake pad and brake caliper area can reach temperatures in excess of 300 degrees C., which many electronic sensors cannot withstand.

From a cost and implementation standpoint, it is desirable to not use any wire harness and to try to utilize existing product already on the vehicle to reduce the cost of transporting the pad wear information to the driver display. It is also desirable that it not be necessary to replace the brake pad wear sensor with the brake pads when they are replaced. It is also desirable that the brake pad wear sensor provides diagnostic (e.g., heartbeat) capabilities, and the sensor must be capable of withstanding the extreme temperatures seen during braking.

### SUMMARY

According to one aspect, a brake pad wear measuring system for measuring brake pad wear for a vehicle disc brake system includes a first coil excitable to create a first magnetic field and a first target associated with the first coil. The first coil and the first target are configured for movement relative to each other along an axis in response to application of the disc brake system. The relative movement along the axis causes the first target to move within the first magnetic field and affect the inductance of the first coil. The first coil and the first target are configured so that the inductance of the first coil is indicative of the amount of brake pad wear. The brake pad wear measuring system also includes a second coil excitable to create a second magnetic field and a second target associated with the second coil. The second coil and the second target are configured for movement relative to each other along the axis in response to application of the disc brake system. The second coil and the second target are configured so that movement of the second target along the axis does not affect the inductance of the second coil. Movement of the second coil and second target relative to each other transverse to the axis affects the inductance of the second coil. The inductance of the second coil is indicative of component shifting transverse to the axis.

According to another aspect, alone or in combination with any other aspect, the brake pad wear measuring system can also include a controller configured to excite the first and second coils to produce the magnetic fields and for measuring the inductance of the first and second coils. The controller can be configured to respond to changes in inductance in the first and second coils caused by movement of the first and second targets target in the magnetic field to provide a signal indicative of brake pad wear.

According to another aspect, alone or in combination with any other aspect, the controller can be configured to calculate brake pad wear in response to the measured inductance of the first coil.

According to another aspect, alone or in combination with any other aspect, the controller can be configured to compensate the calculated brake pad wear in response to the measured inductance of the second coil.

According to another aspect, alone or in combination with any other aspect, the first and second targets can be non-coplanar and the first and second coils can be coplanar. The planes of the targets and coils can be parallel to each other.

According to another aspect, alone or in combination with any other aspect, the first and second targets can be coplanar and the first and second coils can be non-coplanar. The planes of the targets and coils can be parallel to each other.

According to another aspect, alone or in combination with any other aspect, the first target can be configured so that the surface area of the first target overlying the first coil increases in response to brake pad wear. The surface area of the second target overlying the second coil can remain constant regardless of brake pad wear.

According to another aspect, alone or in combination with any other aspect, the first target can have a tapered configuration and the second target can have a rectangular configuration.

According to another aspect, alone or in combination with any other aspect, the second coil can be smaller than the first coil. The size of the second coil can be configured so that movement of the second target along the axis has no effect on the inductance of the second coil.

According to another aspect, a brake pad wear measuring system for measuring brake pad wear for a vehicle disc brake system includes a sensor comprising a housing supporting a first coil excitable to create a first magnetic field, a second coil excitable to create a second magnetic field, and a controller configured to excite the first and second coils and to measure the inductance in the first and second coils. A first target is configured to move within the first magnetic field and affect the inductance of the first coil in response to application of the disc brake system. A second target is configured to move within the second magnetic field and have no effect on the inductance of the second coil in response to application of the disc brake system. The second target and the second coil are configured so that component shifting affects the inductance of the second coil. The system is configured so that movement of the first target in response to brake pad wear affects the inductance of the first coil.

According to another aspect, alone or in combination with any other aspect, the controller can be configured to respond to changes in inductance of the first and second coils caused by movement of the first and second targets in the magnetic fields to provide a signal from the sensor indicative of brake pad wear.

According to another aspect, alone or in combination with any other aspect, the controller can be configured to calculate the brake pad wear in response to the inductance of the first coil, and to compensate the calculated brake pad wear in response to changes in inductance of the second coil.

According to another aspect, alone or in combination with any other aspect, the first and second coils can be arranged coplanar in the sensor housing and the first and second targets can be arranged non-coplanar and parallel to the plane of the first and second coils and to each other.

According to another aspect, alone or in combination with any other aspect, the first and second targets can be arranged coplanar in the sensor housing and the first and second coils can be arranged non-coplanar and parallel to the plane of the first and second targets and to each other.

According to another aspect, alone or in combination with any other aspect, the first and second targets can be configured so that the surface area of the first target overlying the first coil increases in response to brake pad wear, and the surface area of the second target overlying the second coil remains constant.

According to another aspect, alone or in combination with any other aspect, the first target can have a tapered configuration and the second target can have a rectangular configuration.

According to another aspect, alone or in combination with any other aspect, the second coil can be smaller than the first coil. The size of the second coil can be configured so that movement of the second target in response to brake pad wear has no effect on the inductance of the second coil and so that movement of the second target in response to component shifting affects the inductance of the second coil.

### BRIEF DESCRIPTION OF THE DRAWINGS

The foregoing and other features and advantages of the present invention will become apparent to those skilled in the art to which the present invention relates upon reading the following description with reference to the accompanying drawing, in which:

FIG. 1 is a schematic illustration of an example vehicle configuration showing disc brake components mounted on vehicle suspension components.

FIG. 2 is a schematic illustration depicting a brake wear sensor system implemented on an example disc brake configuration, wherein the disc brake is shown in a non-braking condition.

FIG. 3 is a schematic illustration depicting the brake wear sensor system of FIG. 2, wherein the disc brake is shown in a first braking condition with brake pads at a first level of wear.

FIG. 4 is a schematic illustration depicting the brake wear sensor system of FIG. 2, wherein the disc brake is shown in a second braking condition with brake pads at a second level of wear.

FIGS. 5A and 5B are schematic illustrations depicting one configuration of the brake wear sensor system.

FIGS. 6A and 6B are schematic illustrations depicting another configuration of the brake wear sensor system.

FIG. 7 is a graph illustrating the function of the brake wear sensor system.

FIG. 8 is a schematic illustration depicting another configuration of the brake wear sensor system.

### DETAILED DESCRIPTION

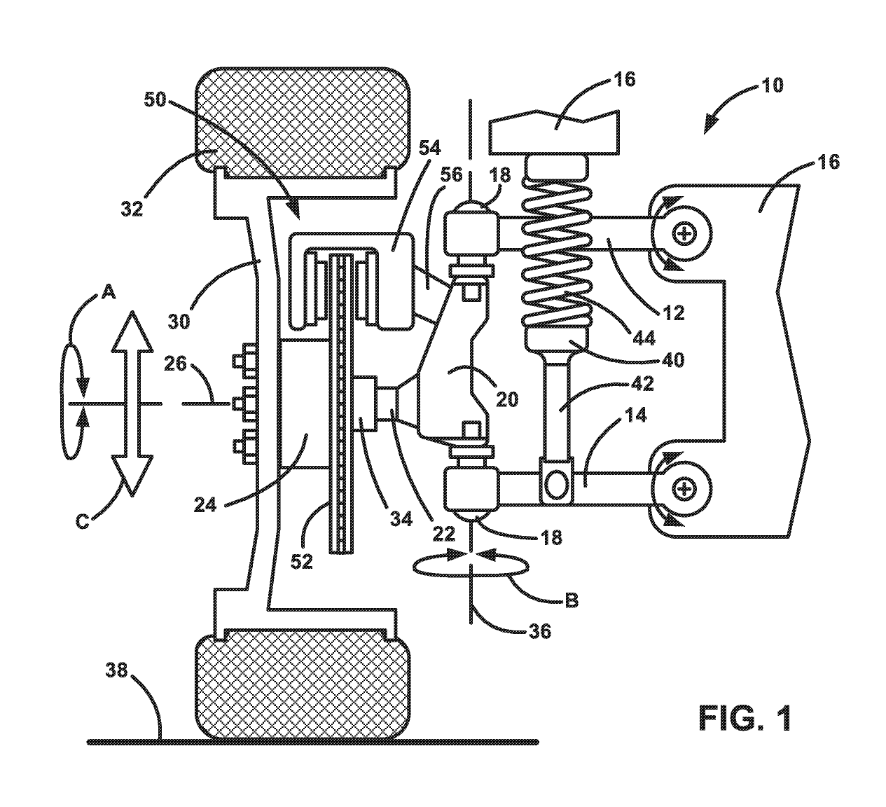

Referring to FIG. 1, an example vehicle suspension system 10 includes an upper control arm 12 and a lower control arm 14 that are connected to the vehicle 16 for pivoting movement. A steering knuckle 20 is connected to free ends of the control arms 12, 14 by ball joints or the like that permit relative movement between the knuckle and control arms. The steering knuckle 20 includes a spindle 22 that supports a wheel hub 24 for rotation (see arrow A) about a wheel axis 26. A wheel or rim 30 and tire 32 can be mounted on the wheel hub 24 by known means, such as lugs and lug nuts. The wheel hub 24 includes bearings 34 that facilitate rotation of the hub, rim 30, and tire 32 about the axis 26. The steering knuckle 20 is itself rotatable about a steering axis 36 (see arrow B) to steer the vehicle 16 in a known manner.

A damper 40, such as a shock absorber or strut, has a piston rod 42 connected to the lower control arm 14 and a cylinder 44 that is supported by structure of the vehicle 16, such as a vehicle frame-mounted bracket. The damper 40 dampens relative movement of the control arms 14, 16, and the steering knuckle 20 relative to the vehicle 16. The damper 40 can thus help dampen and absorb impacts between the road 38 and the tire 32, such as impacts with bumps, potholes, or road debris, that produce up and down movement (see arrow C) of the suspension system 10, the wheel 30, and the tire 32.

The vehicle 16 includes a disc braking system 50 that includes a brake disc 52 secured to the hub 24 for rotation with the hub, wheel 30, and tire 32. The disc braking system 50 also includes a brake caliper 54 that is secured to the steering knuckle 20 by a bracket 56. The disc 52 and the caliper 54 thus move in unison with the steering knuckle 20 through steering movements (arrow B) and suspension movements (arrow C). The disc 52 rotates (arrow A) relative to the caliper 54 and has an outer radial portion that passes through the caliper.

The configuration of the suspension system 10 shown in FIG. 1 is by way of example only and is not meant to limit the scope of the invention. The brake pad wear sensor system disclosed herein can be configured for utilization with any vehicle suspension configuration that implements disc brakes. For example, while the illustrated suspension system 10 is an independent front suspension, specifically an upper and lower control arm/A-arm (sometimes referred to as a double wishbone) suspension, other independent suspensions can be used. Examples of independent suspensions with which the brake pad wear sensing system can be implemented include, but are not limited to, swing axle suspensions, sliding pillar suspensions, MacPherson strut suspensions, Chapman strut suspensions, multi-link suspensions, semi-trailing arm suspensions, swinging arm suspensions, and leaf spring suspensions. Additionally, the brake pad wear sensing system can be implemented with dependent suspension systems including, but not limited to, Satchell link suspensions, Panhard rod suspensions, Watt's linkage suspensions, WOB link suspensions, Mumford linkage suspensions, and leaf spring suspensions. Furthermore, the brake pad wear sensing system can be implemented on front wheel disc brakes or rear wheel disc brakes.

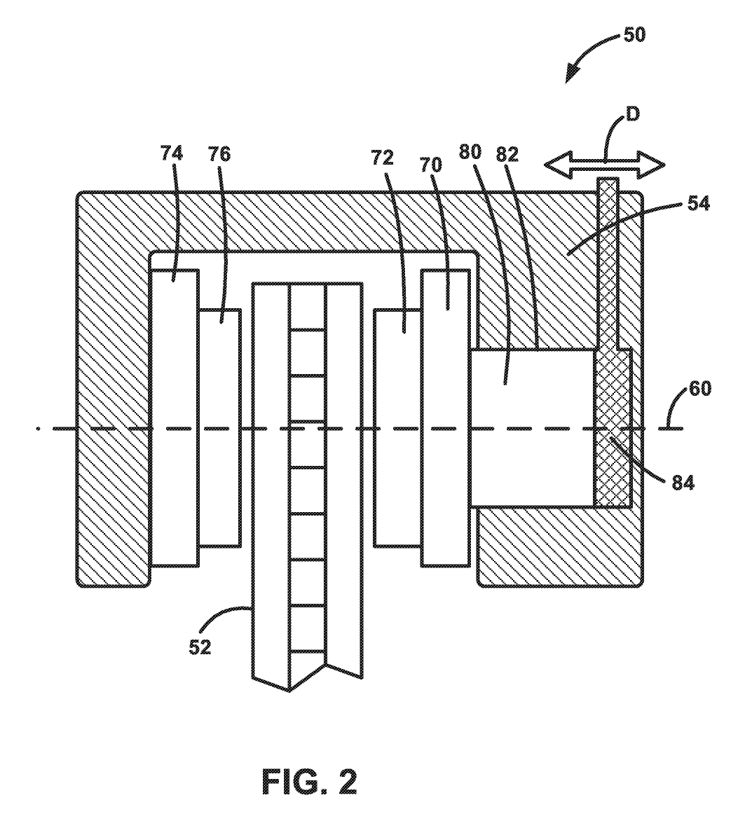

Referring to FIGS. 2-4, the disc braking system 50 is illustrated schematically and in greater detail. The brake system 50 is a single piston floating caliper system in which the connection of the caliper 54 to the vehicle 16 allows for axial movement of the caliper (“float”) relative to the brake disc 52. In this floating caliper configuration, the caliper 54 is permitted to move axially toward and away from the disc 52 (see arrow D) parallel to a braking axis 60.

The brake system 50 includes an inner brake pad holder 70 that supports an inner brake pad 72, and an outer brake pad holder 74 that supports an outer brake pad 76. The inner brake pad holder 70 is supported on a piston 80. The outer brake pad holder 74 is supported on the floating caliper 54. The piston 80 is disposed in a cylinder 82 that is supported on or formed in the floating caliper 54. Brake fluid 84 is pumped into the cylinder 82 in response to driver application of a brake pedal (not shown) in order to actuate the braking system 50.

The brake system 50 is maintained in the unactuated condition of FIG. 2 via bias applied by a biasing member (not shown), such as a spring. When the brake pedal is applied, the brake fluid 84 fills the cylinder 82 and applies fluid pressure to the piston 80, urging it to move to the left, as viewed in FIGS. 2-4. This causes the inner brake pad holder 70 and pad 72 to move along the braking axis 60 toward and the brake disc 52. The inner brake pad 72 engaging the disc 52 creates a reaction force that acts on the floating caliper 54, due to its supporting of the piston 80 and cylinder 82. Since the piston 80 is blocked against movement toward the disc 52 due to the engagement of the inner brake pad 72 with the disc, the brake fluid pressure in the cylinder 82 urges the floating caliper 54 to move to the right, as viewed in FIGS. 2-4. The floating caliper 54, moving to the right, causes the outer brake pad holder 74 and pad 76 to move along the braking axis 60 toward the brake disc 52. The inner pad 76 eventually engages the disc 52, which is now clamped between the inner and outer brake pads.

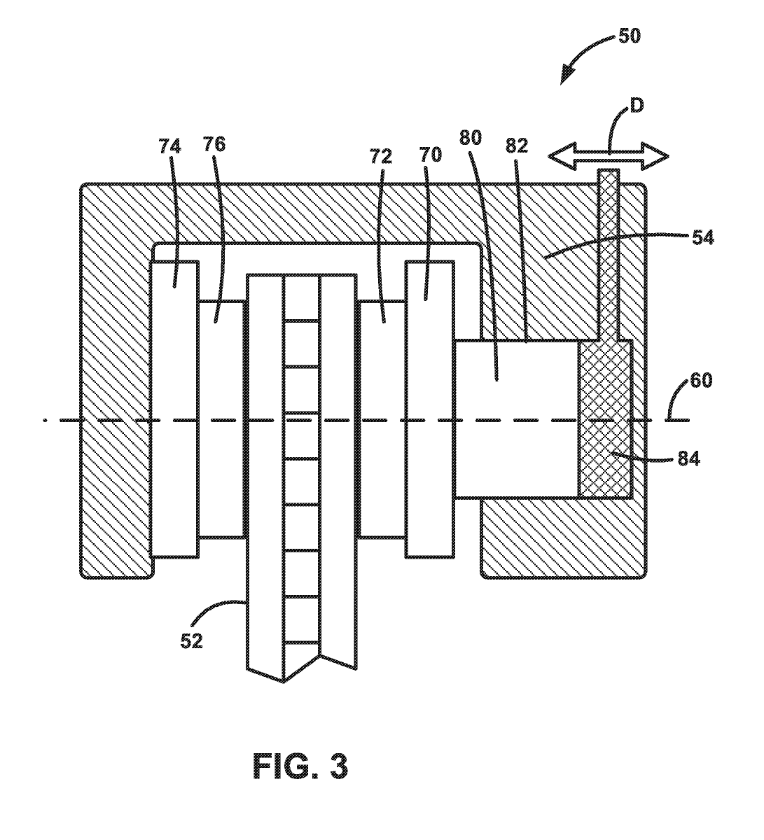

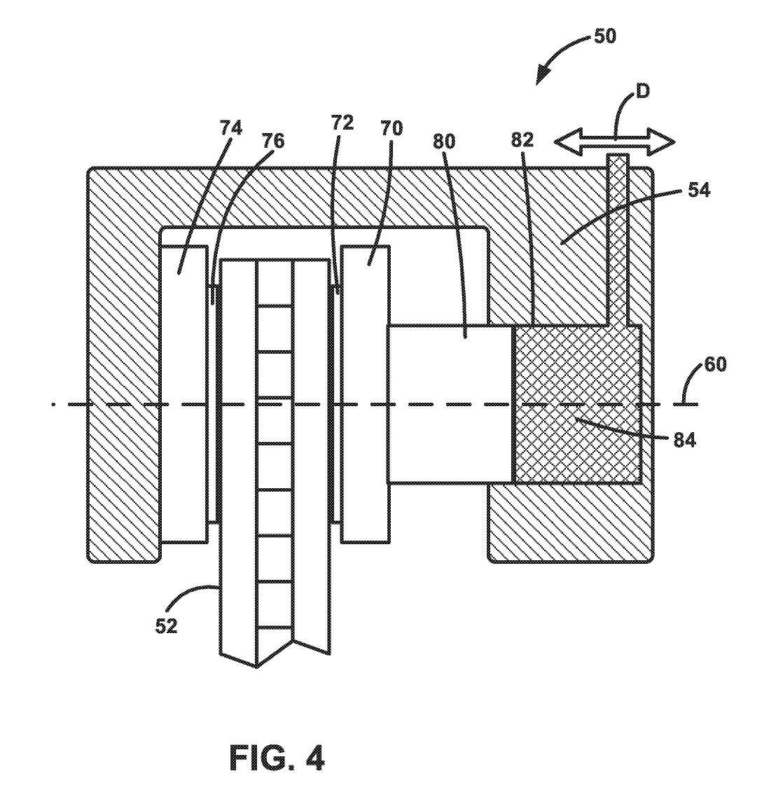

As the brake pads 72, 76 wear down, they become thinner. This is illustrated by comparing the brake pads 72, 76 of FIG. 3, which are fresh, thick, and unworn, to the brake pads of FIG. 4, which are old, thin, and worn-out. As seen in the comparison of FIGS. 3 and 4, owing to the floating caliper configuration of the brake system 50, both the piston 80 and the caliper 54 travel a greater distance when applying the worn pads of FIG. 4 than they do when applying the unworn pads.

A brake pad wear sensing system 100 measures the amount of wear in the brake pads 72, 76 without destroying any portion of the system. In this manner, there are no portions of the wear sensing system 100 that require replacement during routine maintenance and brake pad replacement. The wear sensing system 100 achieves this by measuring directly the distance that braking components travel during brake application. When the brake pads are new, the travel distance is short. As the pads wear, the travel distance increases. By measuring and monitoring this travel distance, the wear sensing system 100 can determine both the degree of brake pad wear and the point at which the pads are considered to be worn out.

The travel distance can be measured via a variety of the brake system 50 components. For example, the travel distance can be measured via the pads 72, 76 themselves, the pad holders 70, 74, the floating caliper 54, or the piston 80. The travel distance can be measured between the moving components themselves, or between a moving component and a stationary component. The stationary component can be a component of the brake system 50, or a component of the vehicle 16, such as the suspension system 10. When the brake pads 72, 76 are new or unworn, the travel distances are comparatively small. As the brake pads 72, 76 wear, the travel distances increase. An increase in the travel distance is indicative of the wear on the brake pads.

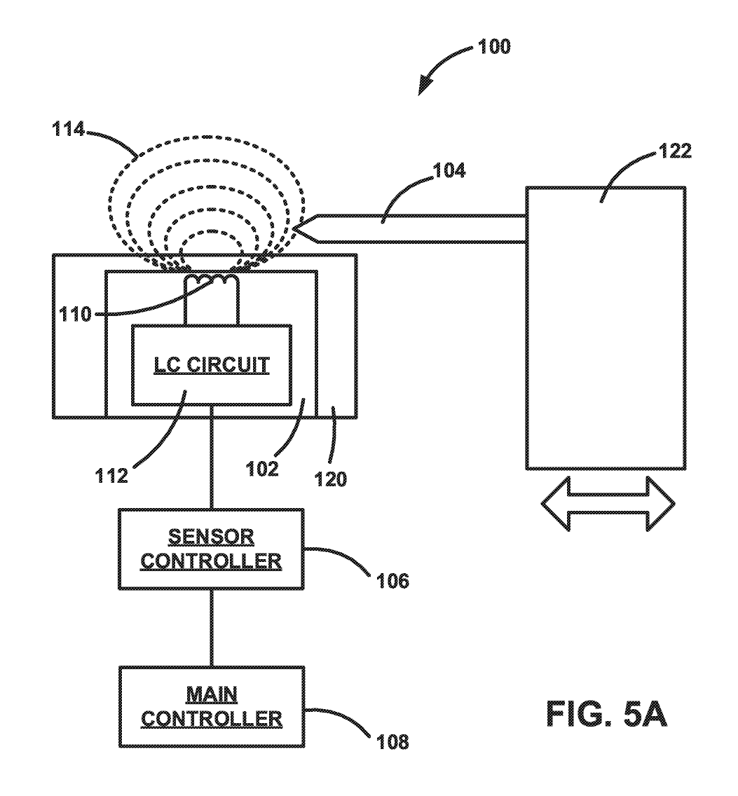

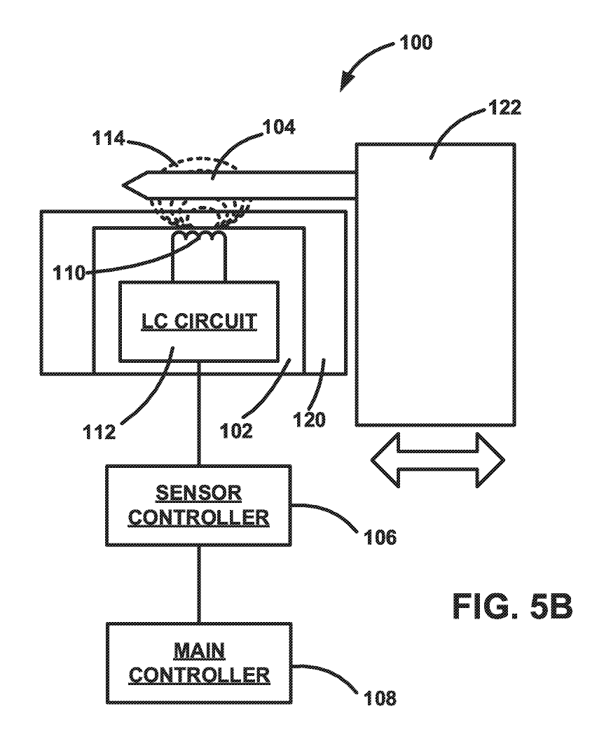

Referring to FIGS. 5A-B, the brake pad wear sensor system 100 includes an inductive sensor 102 and a target 104. The sensor 102 is mounted on a first component 120. The target 104 is mounted on a second component 122. As described in the previous paragraph, the first and second components 120, 122 can have various identities, such as a brake system 50 component, a vehicle 16 component, and a suspension system 10 component. The sensor 102 and target 104 can be mounted for movement in response to brake application (see the arrows in FIGS. 5A-B) or to remain stationary during brake application, as long as at least one component, the sensor 102 and/or the target 104, moves in response to brake application.

### The Inductive Sensor

Due to its not being influenced by dirt and corrosion and not requiring physical contact, the inductive sensor 102 is ideal for implementation in the brake pad wear sensing system 100. Inductive proximity sensing can be implemented as a binary indication, i.e., in an “yes/no” configuration, that provides a “time to replace” indication for the brake pads 72, 76. Inductive proximity sensing can also be implemented as a wear indicator, i.e., with a variable output configuration that can provide, for example, a “percent worn” indication, as well as a “time to replace” indication, for the brake pads 72, 76. FIGS. 5A and 5B illustrate an inductive sensor 102 and its operation.

Referring to FIGS. 5A and 5B, the sensor 102 includes an inductive coil 110 and an LC circuit 112 for exciting the coil and for detecting the target 104. The LC circuit 112 includes an inductor-capacitor (LC) tank circuit and an oscillator for pumping the LC tank circuit. The inductor of the LC tank circuit is the coil 110, which produces a magnetic field 114 when the oscillator pumps the LC tank circuit. When the target 104 is distant from the sensor 102 (see FIG. 5A), the actuator has little or no effect on the field 114 produced by the sensor 102. As the target 104 is brought near the coil (see FIG. 5B), eddy currents form in the conductive metal of the actuator. The magnitude of the eddy currents varies as a function of the distance, the material, and the size of the target 104. The eddy currents form an opposing magnetic field that has the effect of reducing the oscillation amplitude in the LC tank circuit and reduce the effective inductance of the L inductor.

The inductance value L determines the LC tank resonating frequency. The sensor 102 can be configured to measure either the oscillator amplitude change at LC tank circuit or LC tank resonating frequency change. The LC circuit 112 is configured to measure this change in order to detect the target 104. The manner in which the sensor 102 detects the target 104 depends on the configuration of the LC circuit 112. In one configuration, the LC circuit 112 can be configured to detect the presence of the actuator, i.e., a yes/no switch that is toggled when the target 104 reaches a certain predetermined position relative to the sensor. In another configuration, the LC circuit 112 can be configured to determine the actual distance to the target 104.

The brake pad wear sensor system 100 of the example configuration of FIGS. 5A and 5B can be configured as a worn pad detector (presence detector) or a pad wear detector (distance detector). In a worn pad detector configuration, the system 100 is configured to detect only when the brake pads have reached a predetermined amount of wear and to provide an indication that the pads are worn and require servicing. In a pad wear detector configuration, the system 100 is configured to detect the amount of the wear on the pads (e.g., % wear) and to provide an indication of that amount, such as the amount of wear on the pads or the useful life remaining in the pads. The system 100 can be configured to provide periodic warnings as the pads are worn, such as “50% remaining,” “25% remaining,” “10% remaining,” and “service required.”

In operation, when the position of the target 104 changes relative to the piston of the sensor 102, i.e., from the position illustrated in FIG. 5A to the position illustrated in FIG. 5B, this causes the magnetic field 114 to change and the LC circuit 112 to respond, with the sensor 102 providing an output to a sensor controller 106, which performs relevant calculations to determine brake pad wear and whether the brake pads require replacement. It should be noted that, depending on the placement of the sensor 102 and target 104, the wear sensing system 100 can be configured to detect increased wear as a function of increased distance between the sensor and the target, or to detect increased wear as a function of decreased distance between the sensor and the target. The sensor controller 106 can provide the results of these calculations to a main controller 108, such as a vehicle body control module (BCM), which can alert the vehicle operator when necessary.

In one particular configuration, the controller 106 can be implemented in or along with a vehicle anti-lock braking system (ABS) controller. This can be convenient because the ABS system, employing tire rotation sensors, already requires that cables/wiring be routed to the area, which the brake pad wear sensing system 100 can take advantage of. Implementing the controller 106 in/along with the ABS controller is also convenient since it communicates with a main controller 108. In this manner, the brake pad wear indications sensed by the system 100 can be transmitted to the main controller 108 via the sensor controller 106, which can provide the relevant alerts/indications to the vehicle operator, for example, via the instrument panel/gauge cluster.

In another configuration, the sensor 102 can transmit pad wear data wirelessly to the controller 106, which can then relay the data and/or calculations made using the data to the main controller 108. In this configuration, for example, the sensor controller 106 can be implemented in or along with a tire pressure monitoring system (TPMS) controller which is already outfitted to receive wireless signals from TPMS sensors and to communicate with the main controller 108.

In a further configuration, the sensor controller 106 can be integrated in the sensor 102 itself, and the sensor can transmit pad wear data and/or calculation results directly to the main vehicle controller 108, either wired or wirelessly.

The first and second components 120, 122 to which the sensor 102 and target 104 can be mounted can have a variety of identities. Referring to FIGS. 1-4, the first component 120 can be the floating caliper 54, which would allow the sensor 102 to move in response to application of the brakes. Alternatively, the first component 120 can be a stationary component, such as the mounting bracket 56 or a component of the suspension system 10. The second component 122 can be a moving brake system component, such as the caliper 54, the piston 80, one of the pad holders 70, 74, or one of the pads 72,76.

Because effective measurement of the target distance from the inductive sensing coil (D_{S}) is associated with the coil size/diameter, it follows that the larger the coil 110, the better the measurement. Due to the limited space in the area of the brake system 50, and owing to the fact that there are many metal components in that area, a large size/diameter coil may not be possible. Additionally, brake pad thickness can change relatively little (e.g., about 10-15 mm) over its lifetime. This limited space for the sensor 102 and relatively small distance D_{S}, in combination with some tolerance stack up related to surrounding structures, such as vehicle, brake, and suspension components, it can be challenging to sense a small change in axial distance between the sensor 102 and the target 104.

As shown in the example configuration of the sensor system 100 of FIGS. 5A and 5B, the brake pad thickness can be translated into a lateral position of the target 104 relative to the sensor 102 and coil 110. Instead of measuring the axial distance between the face of the coil 110 and the face of the target 104, the spacing between the coil and target faces is maintained constant, and the target is configured to move laterally over the coil. As the target 104 moves relative to the coil 110, the surface area of the target in the vicinity of the field 114 changes. The reduction in coil inductance resulting from the movement of the target 104 over the coil 110 can be measured, for example as a resonating frequency increase in the parallel resistance of the LC circuit or reduced signal amplitude, and used to indicate the position of the target relative to the coil, which can be correlated to a change in thickness (and wear) of the associated brake pad.

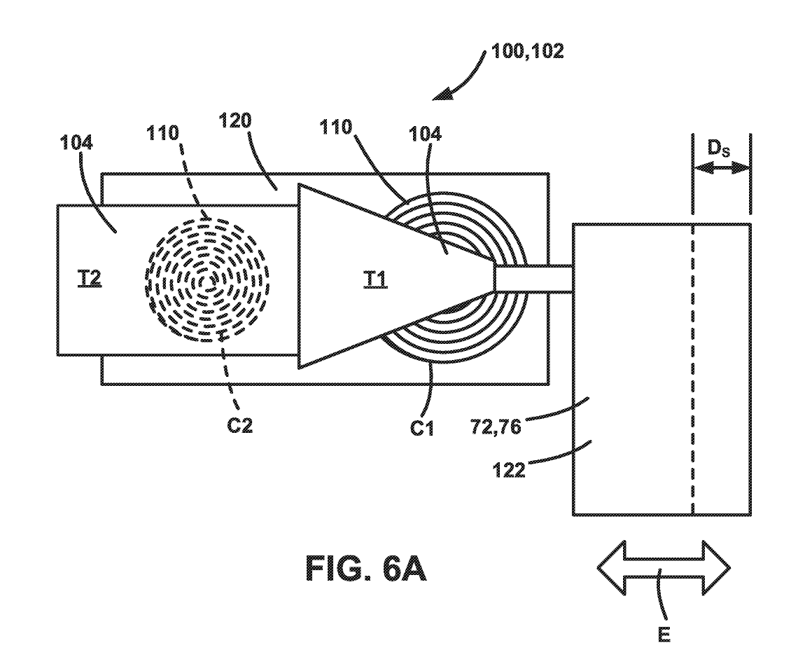

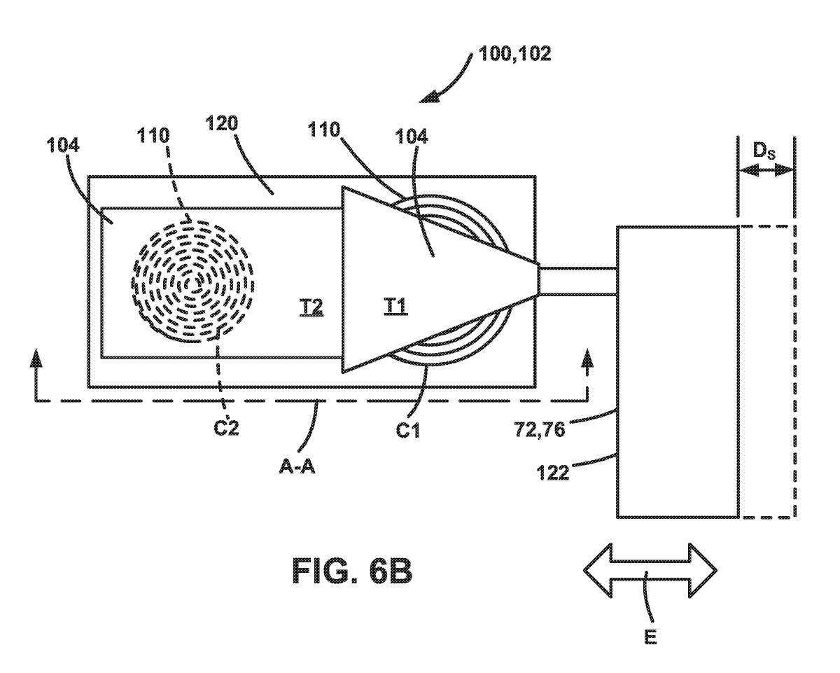

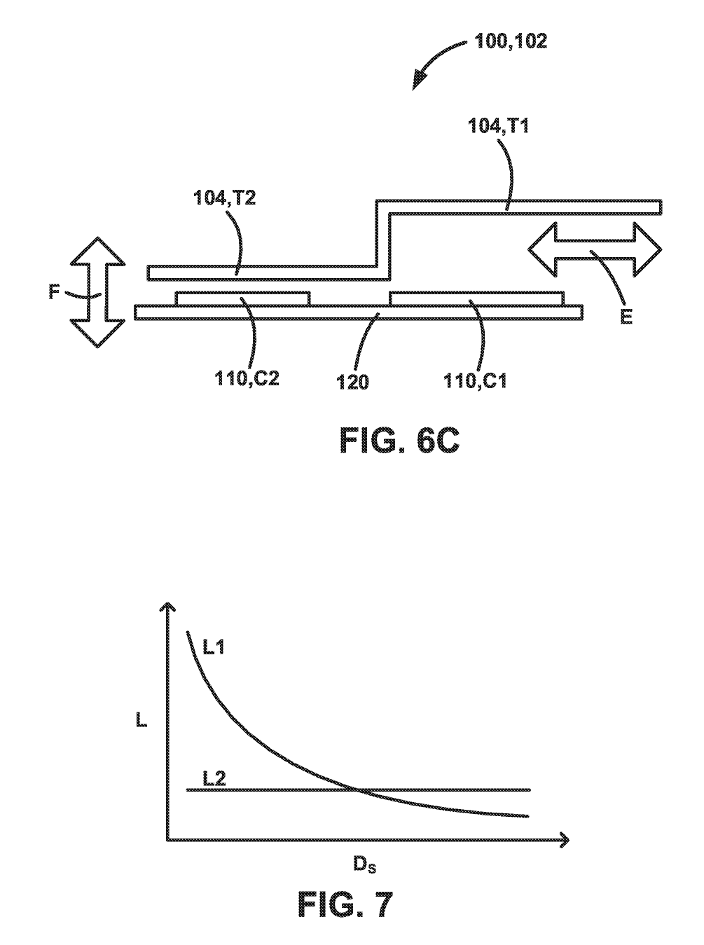

Referring to FIGS. 6A-6C, in one particular configuration of the sensor system 100, the sensor 102 can include two coils 110, each having its own dedicated target 104. The targets 104 can be separate, individual components or portions of a single component. In the example configuration of FIGS. 6A-6C, the targets 104 are portions of a single component. A first target 104, indicated at T1 has an irregular, generally triangular shape and is configured to move laterally (as indicated by arrow E) over its corresponding sensor coil 110, indicated at C1, in response to brake actuation. A second target 104, indicated at T2 has a regular, generally rectangular shape and is also configured to move laterally (as indicated by arrow E) over its corresponding sensor coil 110, indicated at C2, in response to brake actuation.

The target T1 and coil C1 of the sensor 102 are configured to sense brake pad wear. The irregular shape of the target T1 and the fact that its spacing from the surface of the sensor coil C1 is maintained constant improves the response of the sensor 102 to the presence of the target T1. As shown in FIGS. 6A-6B, the area of the triangular target T1 that is exposed to its coil C1 changes as it slides/moves over/along the coil. As the target T1 moves relative to the coil C1 eddy currents are generated in the target. As the surface area of the target T1 overlying the coil C1 changes, the eddy currents change. The eddy currents in the target T1 effect the inductance (L) of the coil C1. More specifically, as the surface area of the target T1 positioned over the coil C1 increases, the eddy currents increase and the inductance L of the coil C1 decreases. The reduction in coil inductance resulting from the movement of the target 104 over the coil 110 can be measured, for example as a resonating frequency increase in the parallel resistance of the LC circuit or reduced signal amplitude, and used to indicate the position of the target T1 relative to the coil C1, which can be correlated to a change in thickness (and wear) of the associated brake pad.

Because brake pad wear measurements are measured as relative distances between brake system 50 components, it will be appreciated that component shifting in these and other vehicle components, such as the suspension system 10, as well a shifting amongst the components of the sensor system 10 itself, can affect the accuracy of the brake pad wear measurement. The target T2 and coil C2 of the sensor 102 are configured to account for this possibility by being unresponsive to lateral target T2 movement (in the direction of arrow E), and responsive to movement of the target T2 in directions transverse to the lateral direction (arrow E).

The regular, rectangular shape of the target T2 and the fact that the sensor coil C2 is small and confined within or covered completely by the target T2 at all times (See FIGS. 6A and 6B) renders the coil C2 insensitive to lateral movement of the target T2 in the lateral direction (arrow E). As shown in FIGS. 6A-6B, the area of the rectangular target T2 that is exposed to its coil C2 is fixed and completely covers the coil as it slides/moves over/along the coil. As the target T2 moves relative to the coil C2 eddy currents are generated in the target. Since the surface area of the target T2 overlying the coil C2 remains constant and completely covers the coil C2, the eddy currents remain constant regardless of the lateral position (arrow E) of the target T2. The eddy currents in the target T2 do effect the inductance (L) of the coil C2 but, since the surface area covering the coil C2 is constant and at a fixed distance from the surface of the coil C2, the eddy currents in the target T2, and the inductance L of the coil C2, remain constant.

If, however, the target T2 moves transverse to the lateral direction (arrow E), such as closer to or away from the coil C2, as shown generally at arrow F in FIG. 6C, the eddy currents generated in the target T2 change, which produces a corresponding change in the inductance of the coil C2. For example, if the target T2 moves closer to the coil C2, the eddy currents in the target T2 increase and the inductance L of the coil C2 decreases. As another example, if the target T2 moves away from the coil C2, the eddy currents in the target T2 decrease and the inductance L of the coil C2 increases.

The configuration of the sensor system 100 illustrated in FIGS. 6A-6C addresses an issue that can arise in an inductive sensor including a single target and coil. Brake pad wear is measured along the braking axis 60 (see FIGS. 2-4), and the wear is specifically measured as the change in distance that the component 122 (e.g., brake pad 70, 74, brake pad holder 72, 76, brake caliper 54) moves in applying the vehicle brakes. In FIGS. 6A-6C, the component 122 is illustrated as a brake pad 72, 76 for purposes of example only, so that the change in its thickness between the unworn (FIG. 6A) and worn (FIG. 6B) condition can be illustrated.

The configuration of the sensor system 100 in FIGS. 6A-6C accounts for component shifting in directions transverse (arrow F) to the lateral direction (arrow E) along which brake pad wear is measured. As the brake pad 72, 76 wears and gets thinner, both of the targets T1 and T2 move in the same direction relative to the coils C1 and C2. This movement produces a change in the inductance L1 of coil C1, but no change in the inductance L2 of coil C2. This is illustrated in FIG. 7. In FIG. 7, the axis labeled Dₛ shows brake pad wear increasing to the right along the axis. As shown in FIG. 7, increasing brake pad wear (Dₛ) results in decreased inductance L1 of the coil C1 (increased target T1 surface area over coil C1). Meanwhile, the inductance L2 of the coil C2 remains constant due to the constant of the target T2 surface area over coil C2. Thus, as the brake pad 72, 76 wears, the inductance L1 should decrease correspondingly, while the inductance L2 should remain constant. Any change in the inductance L2 would trigger a warning that the accuracy of the thickness measurement determined via inductance L1 is suspect due to the possibility that components have shifted.

Recalling that the coils 110 are implemented in an LC tank circuit as described above, in operation, the sensor 102 can be configured to measure the change in inductance of coils C1 and C2 through the change in amplitude of the oscillator in the associated LC tank circuit or the change in resonating frequency of the associated LC tank circuit. Advantageously, sensing system 100 can be configured to measure brake pad wear as a function of the inductance L1 of coil C1, and can monitor for errors due to component shifting as a function of the inductance L2 of coil C2.

FIG. 6C is a side view taken generally along line A-A in FIG. 6B. Referring to FIG. 6C, the targets 104 are configured such that the target T2 is positioned close to its coil C2. This close spacing helps ensure that the inductance of the coil C2 remains constant throughout the range of lateral movement of the target T2. This doesn't mean that T1 and T2 cannot be on the same plane. It just emphasizes that closer distance between T2 and C2 will reduce error introduced by the target flag lateral movement around coil C2 and also reduce the flag and coil C2 size requirements. The target T2 is sized to cover the coil C2, and the coil C2 has a comparatively small size, both of which help ensure that the inductance of the coil C2 remains constant, absent some movement of the target T2 transverse (arrow F) to the lateral direction. The small size of the coil C2 makes it sensitive to the target T2 moving away from its surface (arrow F) while, at the same time, makes it insensitive to lateral movement (arrow E).

The measured inductance of the coil C2 can be used not only to determine that component shifting has occurred, but also to compensate the brake pad wear determined via the measured inductance of coil C1. Through pre-calibration of the sensor system 100, changes in inductance measured at coil C2 can be mapped to relative movement between the coils 110 and targets 104 in the direction of arrow F. This mapping can, for example, be a first table that charts spacing between the coil C2 and the target T2, and the resulting inductance of coil C2. Additionally, relative movements between the coils 110 and targets 104 can be mapped to the effect it has on the inductance of C1. This mapping can, for example, be a second table that charts measured inductance of coil C1 for various levels of brake pad wear at varied spacing between the coil C1 and the target T1.

During use, when a change in the inductance measured at coil C2 is detected, it can be correlated via the first table to the distance of transverse (arrow F) relative movement between the coil C2 and target T2. This distance can then be used to compensate via the second table the brake pad wear determined via the measured inductance of the coil C1.

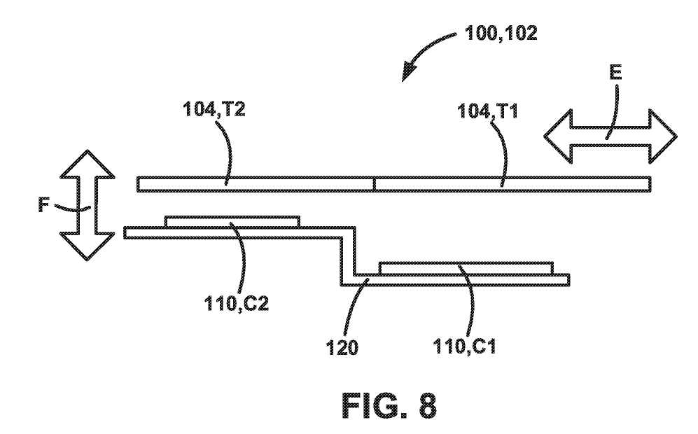

A variation in the configuration of the sensor system 100 are illustrated in FIG. 8. The sensor system 100 illustrated in FIG. 8 function identically to the sensor system configuration of FIGS. 6A-6C. More specifically, the sensor system 100 of FIG. 8 implements coil/target pairs in which a coil C1 and target T1 measure brake pad wear through relative movement of the components in a lateral direction (arrow E), and coil/target pairs in which a coil C2 and target T2 monitor for component shifting transverse to the lateral direction (arrow F).

FIG. 8 is a side view illustrating an alternative system configuration for achieving the desired spacing between the target T2 and the coil C2. FIG. 8 can be considered an alternative view taken along line A-A in FIG. 6B. In the configuration of FIG. 8, instead of the targets T1 and T2 being offset in the direction of arrow F, the coils C1 and C2 are offset in this direction. The targets 104 are planar in configuration. The operation of the sensor system 100 is identical to that described above with regard to FIGS. 6A-6C.

From the above description of the invention, those skilled in the art will perceive improvements, changes and modifications. Such improvements, changes and modifications within the skill of the art are intended to be covered by the appended claims.

We claim:

1. A brake pad wear measuring system for measuring brake pad wear for a vehicle disc brake system, comprising:
a first coil excitable to create a first magnetic field and a first target associated with the first coil, wherein the first coil and the first target are configured for movement relative to each other along an axis in response to application of the disc brake system, the relative movement along the axis causing the first target to move within the first magnetic field and affect the inductance of the first coil, wherein the first coil and the first target are configured so that the inductance of the first coil is indicative of the amount of brake pad wear;
a second coil excitable to create a second magnetic field and a second target associated with the second coil, wherein the second coil and the second target are configured for movement relative to each other along the axis in response to application of the disc brake system, wherein the second coil and the second target are configured so that movement of the second target along the axis does not affect the inductance of the second coil, and wherein movement of the second coil and second target relative to each other transverse to the axis affects the inductance of the second coil, the inductance of the second coil being indicative of component shifting transverse to the axis.

2. The brake pad wear measuring system recited in claim 1, further comprising a controller configured to excite the first and second coils to produce the magnetic fields and for measuring the inductance of the first and second coils, wherein the controller is configured to respond to changes in inductance in the first and second coils caused by movement of the first and second targets target in the magnetic field to provide a signal indicative of brake pad wear.

3. The brake pad wear system recited in claim 2, wherein the controller is configured to calculate brake pad wear in response to the measured inductance of the first coil.

4. The brake pad wear system recited in claim 3, wherein the controller is configured to compensate the calculated brake pad wear in response to the measured inductance of the second coil.

5. The brake pad wear measuring system recited in claim 1, wherein the first and second targets are non-coplanar and the first and second coils are coplanar, the planes of the targets and coils being parallel to each other.

6. The brake pad wear measuring system recited in claim 1, wherein the first and second targets are coplanar and the first and second coils are non-coplanar, the planes of the targets and coils being parallel to each other.

7. The brake pad wear measuring system recited in claim 1, wherein the first target is being configured so that the surface area of the first target overlying the first coil increases in response to brake pad wear, and the surface area of the second target overlying the second coil remains constant regardless of brake pad wear.

8. The brake pad wear measuring system recited in claim 1, wherein the first target has a tapered configuration and the second target has a rectangular configuration.

9. The brake pad wear measuring system recited in claim 1, wherein the second coil is smaller than the first coil, the size of the second coil being configured so that movement of the second target along the axis has no effect on the inductance of the second coil.

10. A brake pad wear measuring system for measuring brake pad wear for a vehicle disc brake system, comprising:
a sensor comprising a housing supporting a first coil excitable to create a first magnetic field, a second coil excitable to create a second magnetic field, and a controller configured to excite the first and second coils and to measure the inductance in the first and second coils;
a first target configured to move within the first magnetic field and affect the inductance of the first coil in response to application of the disc brake system;
a second target configured to move within the second magnetic field and have no effect on the inductance of the second coil in response to application of the disc brake system;
wherein the second target and the second coil are configured so that component shifting affects the inductance of the second coil, and wherein the system is configured so that movement of the first target in response to brake pad wear affects the inductance of the first coil.

11. The brake pad wear measuring system recited in claim 10, wherein the controller is configured to respond to changes in inductance of the first and second coils caused by movement of the first and second targets in the magnetic fields to provide a signal from the sensor indicative of brake pad wear.

12. The brake pad wear system recited in claim 10, wherein the controller is configured to calculate the brake pad wear in response to the inductance of the first coil, and to compensate the calculated brake pad wear in response to changes in inductance of the second coil.

13. The brake pad wear measuring system recited in claim 10, wherein the first and second coils are arranged coplanar in the sensor housing and the first and second targets are arranged non-coplanar and parallel to the plane of the first and second coils and to each other.

14. The brake pad wear measuring system recited in claim 10, wherein the first and second targets are arranged coplanar in the sensor housing and the first and second coils are arranged non-coplanar and parallel to the plane of the first and second targets and to each other.

15. The brake pad wear measuring system recited in claim 10, wherein the first and second targets are configured so that the surface area of the first target overlying the first coil increases in response to brake pad wear, and the surface area of the second target overlying the second coil remains constant.

16. The brake pad wear measuring system recited in claim 15, wherein the first target has a tapered configuration and the second target has a rectangular configuration.

17. The brake pad wear measuring system recited in claim 10, wherein the second coil is smaller than the first coil, the size of the second coil being configured so that movement of the second target in response to brake pad wear has no effect on the inductance of the second coil and so that movement of the second target in response to component shifting affects the inductance of the second coil.
